(19) United States
(12) Patent Application Publication
(10) Pub. No.: US 2006/0185535 A1
(43) Pub. Date: Aug. 24, 2006

(54) Stencil manufacture

(76) Inventors: Marc P.Y. Desmulliez, Edinburg (GB); Robert W. Kay, West Lothian (GB)

Correspondence Address: King & Partners, PLC, 170 College Avenue, SUITE 230, HOLLAND, MI, 49423, US

(21) Appl. No.: 10/543,963

(22) PCT Filed: Jan. 27, 2004
(86) PCT No.: PCT/GB04/00318

§ 371 Date: Mar. 21, 2006

(30) Foreign Application Priority Data
Jan. 31, 2003 (GB) 0302222.5

(51) Int. Cl. B41C 1/14

(52) U.S. Cl. 101/128.4

(57) ABSTRACT

A method of forming a screen-printing stencil comprising electroforming the stencil using a bi-polar electrical signal. The bi-polar signal comprises a cathodic pulse (22) and an anodic pulse (24). When the cathodic pulse (22) is applied during the electroforming process, metal is deposited. When the anodic pulse (24) is applied, metal is removed. The cathodic pulse (22) has a longer duration than the anodic pulse (24). The ratio of the magnitude of the anodic pulse (24) to the magnitude of the cathodic pulse (22) is greater than one.

The present invention relates to a method for making a stencil for use in screen-printing.

Screen printing stencils define a pattern with open areas on the stencil. A material is printed through the open areas of the stencil, so that the printed deposits match approximately those open areas. Screen-printing stencils have a number of uses in the electronic substrate fabrication and electronic assembly industries. These include, but are not limited to the printing of printed circuit boards, depositing solder paste and conductive adhesive for electronic packaging and the printing of conductor and resistor circuits.

The drive to make electronic devices smaller, faster and lighter, but at the same time with higher pin counts, has lead to a trend of using advanced packaging techniques, which eliminate the use of leads for interconnects. Using advanced packaging techniques enables an increase in the number of connections and a decrease in package size, and so an increase in package performance and a drop in production cost. One of the fastest and most cost attractive options to package electronic components is to screen print the interconnect material through the apertures of a stencil and then package the components accordingly. However, currently there are practical limitations. This is because known processes for making stencils do not allow the fabrication of stencils with perfect apertures at a fine pitch. For small features (e.g. sub 100 micron), it is critical that the stencil apertures are perfectly formed, with high tolerances to enable the same paste volume to be effectively released from each aperture and printed.

Conventional metal stencils can be fabricated in various ways. In a first known method chemical etching is used. This involves firstly forming a resist mask by applying a resist to a metal foil and optically patterning the resist through a mask. The resist is then developed leaving the pattern of the mask on the foil. The foil with its resist mask is then submerged in a chemical etchant. The areas covered by the resist mask are protected and stop the metal foil being etched away. In contrast, the exposed areas not covered by the resist mask are etched away, thereby forming apertures through the metal foil and so defining a stencil. A disadvantage of chemical etched stencils is that they cannot be reliably manufactured with small apertures and fine pitch due to the undercutting process caused by etching. This can cause problems when the stencil is used, because paste can get trapped in the undercut sidewall. Therefore, such stencils are only used for larger pitch features.

In another method laser cutting is used. This involves mounting a metal foil in a frame. Stored in a computer is a data file that represents an image of the apertures that are required to form the desired stencil. Under control of the computer, a laser traces out this image ablating each aperture sequentially. However, the laser cutting process for the formation of screen-printing stencils also has some drawbacks for forming fine pitch apertures. Notably the laser cuts rough aperture walls, which can cause paste or adhesive to get trapped in the apertures during printing. Another problem is that the process can be quite messy at fine pitches, spewing molten metal around the aperture and often causing an undesirable lip around the edge of some apertures. Furthermore, incomplete removal of metal can occur leaving blocked apertures. Another problem is that the diameter of apertures can vary by +/−10 microns at fine pitches.

Yet another method for manufacturing stencils uses DC electroforming. This process starts with a properly prepared mandrel, typically a stainless steel sheet, which is laminated with a dry film photo resist. The resist is exposed to a collimated UV light source through a mask, and then developed, leaving a pattern of the apertures. Once this is done, the patterned mandrel is submerged in a suitable electroplating solution and exposed to a high DC electrical current, which starts the plating process. Metal ions are deposited around the photo resist to the desired stencil thickness. The next step is to strip away the polymerised photo resist and then mechanically remove the foil. An example of a DC electroforming process is described in U.S. Pat. No. 5,359,928.

A problem with DC electroforming technology is that it cannot reliably produce a stencil at sub-150 micron pitches. Hence at these levels, the aperture shape and size vary from one to another. Also, traditional DC electroforming does not plate uniformly across a substrate due to current crowding effects. This uneven current density causes an uneven plating rate and hence an overall variation of plated metal across the stencil. It also tends to cause a gasket or lip around the aperture, which can cause bleeding during the printing process.

An object of the invention is to provide an improved method for fabricating stencils and an improved resolution stencil.

According to one aspect of the present invention there is provided a method of forming a stencil comprising electroforming the stencil using a bi-polar electrical signal that comprises a plurality of bi-polar waveforms.

Using bi-polar electroforming has several inherent advantages over traditional DC electroforming. Most notably, it allows the material distribution to be controlled thereby to give an even metal deposition across the stencil, which means that the edge definition of features formed using this method is excellent. Also, material properties can be controlled, for example, hardness, intrinsic stress, brittleness, ductility, and crystal structure. Furthermore, the current efficiency is improved, which decreases hydrogen formation, thus lowering pitting and decreasing residual stress. In addition, in practice, using this method reduces or eliminates the need for organic additives.

By bi-polar waveform, it is meant a waveform consisting of a positive pulse and a negative pulse. When the positive pulse of the bi-polar waveform is applied during the electroforming process, metal is deposited. This positive pulse will be referred to as the cathodic pulse. When the negative pulse is applied, metal is removed. This negative pulse will be referred to as the anodic pulse.

Preferably, the cathodic pulse has a longer duration than the anodic pulse. Preferably, the cathodic pulse is at least twice the duration of the anodic pulse. The ratio of cathodic pulse duration to anodic pulse duration may be in the range of 2:1 to 100:1.

Preferably, the cathodic pulse has a lower peak value than the anodic pulse. The ratio of cathodic pulse height to anodic pulse height may be in the range of about 1:1.5 to 1:20. The anodic pulse height may be substantially 1.5 times the cathodic pulse height. The anodic pulse height may be substantially 20 times the cathodic pulse height.

The method may involve varying the bi-polar waveforms. For example, initially a bi-polar waveform that is suitable to provide smooth stencil sidewalls may be used, and subsequently, towards the end of the process, the waveform may be varied in order to provide a rough upper surface. This may be done by varying the frequency and/or the durations of the cathodic and anodic pulses and/or the magnitudes of the cathodic and anodic pulses and/or the relative widths of the cathodic and anodic pulses and/or the relative magnitudes of the cathodic and/or anodic pulses.

The waveform may be square or spiked or sinusoidal.

In general it is preferred that bi-polar waveform is a current waveform. In this case, the voltage is controlled and it is the current that is varied. Of course, the bi-polar waveform could equally be a voltage waveform. In this case, the voltage waveform is varied with respect to current.

Where the bi-polar waveform is a current waveform, it may have a pulse width in the millisecond range 1 ms-999 ms. In this case, the voltage range depends on the size of the substrate.

The average current density of the anodic pulse is less than the average current density of the cathodic waveform.

The current may have a peak density in the range of from 1 Am/dm² to 50 A/dm², where A/dm²=Amps per decimeter squared and a decimeter is 100 cm².

The average current density may be in the range 3-15 A/dm², where the average current density is an average of the current across one waveform.

The step of electroforming the stencil may comprise providing a mould on a conducting surface, the mould defining exposed areas of the conducting surface; immersing the mould and conducting surface in an ionic solution and electroplating areas exposed by the mould using the bi-polar current or voltage signal.

The mould may be provided on an intermediary layer that is carried by the conducting surface. The intermediary layer may be a sacrificial lift-off layer for allowing easy removal of the stencil from the substrate.

According to another aspect of the present invention there is provided a system for forming a stencil comprising a mask on a conducting surface, the mask defining exposed areas of the conducting surface, and means for electroplating areas exposed by the mask using a bi-polar current or voltage signal that comprises a plurality of waveforms each having a cathodic pulse and a anodic pulse.

Preferably, the cathodic pulse has a longer duration than the anodic pulse. Preferably, the cathodic pulse is at least twice the duration of the anodic pulse. The ratio of cathodic pulse duration to anodic pulse duration may be in the range of 2:1 to 100:1.

Preferably, the cathodic pulse has a lower peak value than the anodic pulse. The ratio of cathodic pulse height to anodic pulse height may be in the range of about 1:1.5 to 1:20. The anodic pulse height may be substantially 1.5 times the cathodic pulse height. The anodic pulse height may be substantially twenty times the cathodic pulse height.

The bi-polar waveform preferably has a greater anodic to cathodic pulse ratio, and a shorter anodic pulse time than cathodic pulse time.

The waveform may be square or spiked or sinusoidal.

The bi-polar waveform may be a current waveform. Alternatively, the bi-polar waveform could be a voltage waveform.

When the bi-polar waveform is a current waveform, the average current density of the anodic pulse is preferably less than the average current density of the cathodic waveform.

When the bi-polar waveform is a current waveform, the average current density may be in the range 3-10 A/dm². The waveform may have an average current density of 7 A/dm², a frequency of 20 Hz (50 ms), a cathodic pulse duration of 45 ms at 10 A/dm², and an anodic pulse duration of 5 ms at 20 A/dm².

When the bi-polar waveform is a current waveform, it may have a pulse width in the millisecond range 1 ms-999 ms. In this case, the voltage range depends on the size of the wafer.

When the bi-polar waveform is a current waveform, the current may have a peak density in the range of anywhere from 1 Am/dm² to 50 A/dm², where A/dm²=Amps per decimeter squared and a decimeter is 100 cm².

A controller may be provided for controlling parameters of the bi-polar signal. The controller may be operable to vary parameters of the bi-polar signal at different stages in the electroforming process. The parameters may be the frequency and/or the durations of the cathodic and anodic pulses and/or the magnitudes of the cathodic and anodic pulse and/or the relative widths of the cathodic and anodic pulses and/or the relative magnitudes of the cathodic and/or anodic pulses.

By varying the signal parameters at different stages in the electroforming process, the physical characteristics of the stencil can be caused to be different in different areas thereof. This means that in the early stages of the process, the pulse can be controlled so as to provide very smooth sidewall definition, but at the latter stages, once plating is substantially finished, the parameters could be changed so that the stencil has a rough upper surface. Providing a rough upper surface aids in the printing process, because it improves rolling of the paste onto the stencil. Having smooth sidewalls aids printing, because it encourages better material release from the apertures.

According to yet another aspect of the present invention there is provided a method comprising: forming a stencil by providing a mould on a conducting surface, the mould defining exposed areas of the conducting surface; electroplating the exposed areas of the conducting surface using a bi-polar current or voltage signal, thereby to form a stencil and using the stencil to print features onto a board or substrate or some other suitable medium.

Various aspects of the invention will now be described by way of example only with reference to the accompanying drawing, of which:

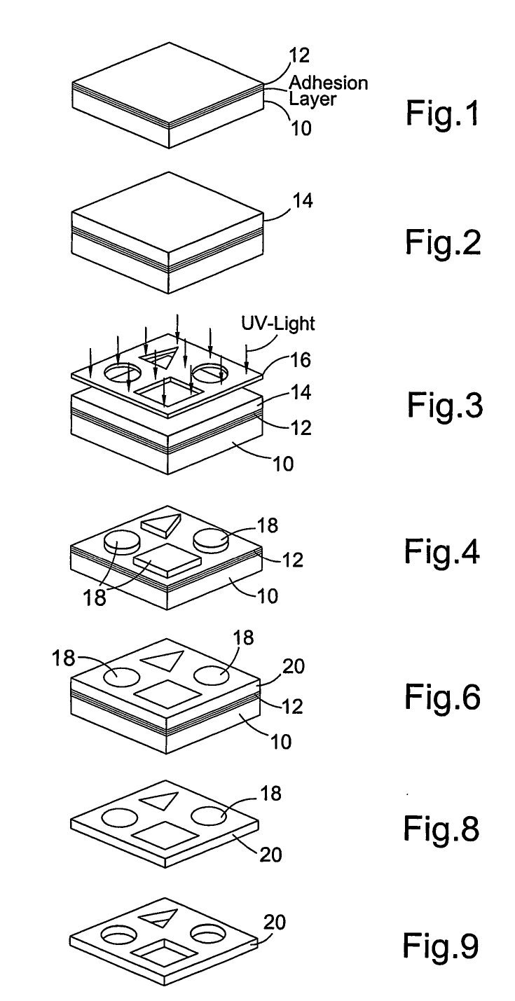

FIG. 1 is a perspective view of a substrate for use in forming a stencil;

FIG. 2 is a perspective view of the substrate of FIG. 1, on which resist is deposited;

FIG. 3 is a perspective view of the substrate of FIG. 2, to which a mask is applied;

FIG. 4 is a perspective view of the substrate of FIG. 3 after patterning and development of the resist;

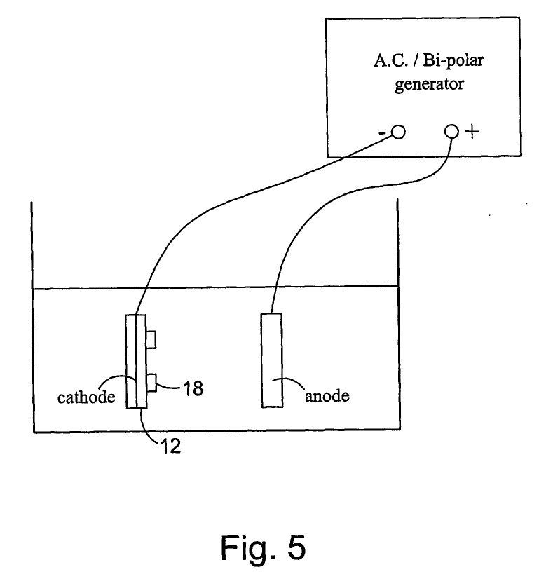

FIG. 5 is a schematic representation of a system for electroforming a stencil;

FIG. 6 is a perspective view of an electroformed stencil on the substrate;

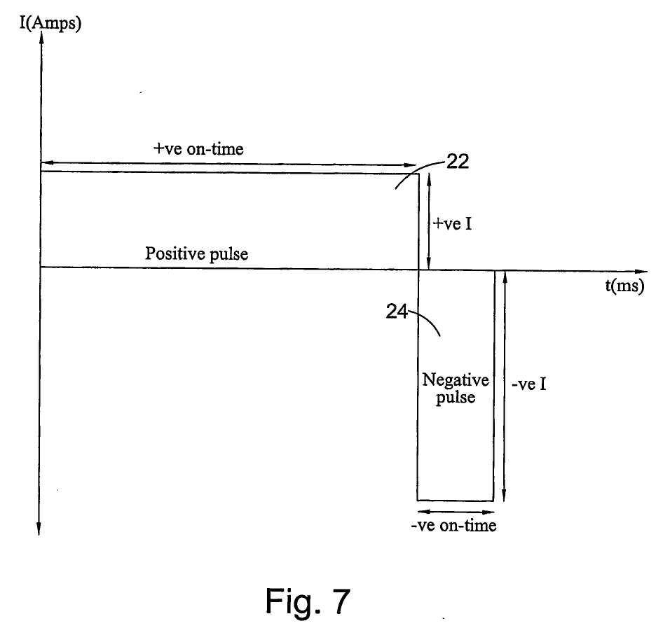

FIG. 7 shows an example of a bi-polar pulse applied during the electroplating process;

FIG. 8 is a perspective view of the stencil of FIG. 7, after removal from the substrate, and

FIG. 9 is a perspective view of the final stencil.

The starting material in the stencil forming process is a substrate 10 of, for example, glass, as shown in FIG. 1. Of course any other suitable substrate could be used, for example a dielectric material such as silicon or ceramic. The substrate 10 is cleaned using any suitable method, for example, successive immersions in methanol, acetone and piranha solution and then de-ionised water. A conductive seed layer of metal 12 is then deposited on an upper surface of the glass wafer 10. This can be done using an electron beam evaporator or any other suitable technique, such as sputtering or thermal evaporation. The metal 12 must have a thickness that is sufficient to allow it to conduct. The thickness may be in the range of 0.1 to 0.3 microns.

A variety of metals can be used for the seed layer 12 either alone or as part of a bi-metallic or tri-metallic layered structure. However, as an example, titanium could be used, as could a titanium/copper/titanium layered structure or a chrome/copper/gold layered structure. When using a glass substrate it is preferred that the base metal layer is titanium or chrome. This is because these metals promote adhesion to the substrate. As an alternative, rather than using a glass substrate that is coated with metal, a metal substrate could be used.

Once the metal layer 12 is formed, photoresist 14 is deposited on it, as shown in FIG. 2. Any suitable photoresist 14 could be used, but a preferred example is SU-8. As is well known, this is a negative resist. The photoresist 14 can be deposited in any suitable manner, for example spin coating. In order to give a photoresist thickness of approximately 50 microns the spin speed may be around 3000 revs per minute. Of course, this could be varied according to the thickness of the stencil required. Alternatively, the resist could be applied as a film or using a doctor blading machine, also known as a knife coater. The resist covered glass wafer/substrate is than baked at a temperature in the range of 50-130° C., for example 90° C., on a hot plate or oven for between one minute and two hours. As will be appreciated, the absolute temperature and time here depend on the thickness of the photoresist. The thicker the photoresist 14 the longer it takes to bake.

After the photoresist 14 is baked, it is patterned through a photomask 16 using photolithography, as shown in FIG. 3. The photomask is a chrome-on-glass mask, although a mask made on a high-resolution photoplotter could also be used. The resist 14 is exposed through the mask 16 using a highly collimated light source having a suitable wavelength. For SU-8, the wavelength is typically in a range of about 350 nm to 400 nm, preferably 365 nm. The energy of the light used is in the range of 100-5000 mJ/cm². However, it will be appreciated that the wavelength and energy used will depend on the sensitivity of the resist. The patterned resist 14 is then baked using, for example, a hotplate or an oven. The baking temperature is in the range 50-130° C., preferably 90° C. The duration of baking is dependant on the photoresist thickness but may be anywhere between 1 minute and 2 hours. Of course, it will be appreciated that this post-patterning bake may not be necessary for other types of resist.

After baking, the photoresist 14 is developed in Microposit EC Solvent or acetone or any other suitable solvent. Development can be done by complete immersion in the solution, with some agitation thereof, or by spraying the solution onto the surface. Using Microposit EC Solvent, the time taken to develop the resist is of the order of 2 to 3 minutes, although it will be appreciated that this time will vary depending on the developing chemical used. Once the resist is developed, mesas 18 of resist in the areas that were exposed remain, and all of the other resist is removed. These patterned resist mesas 18 define the aperture shapes for the stencil, as shown in FIG. 4.

Once the mesas 18 are formed, the electroforming process is implemented. FIG. 5 shows a system that is suitable for this. This includes a variable current source that is operable to output a bi-polar current signal; an anode and a bath for the electroplating solution. Electroplating can be done using any suitable solution, but a preferred option is a solution made with nickel sulphamate (330 g per litre), boric acid (30 g per litre) and nickel chloride (15 g per litre). In this case, a 99.99% pure nickel anode is used. The solution should be at 50° C. The wafer is submerged in the solution in the plating bath. Once this is done, an AC bi-polar current is applied between the conductive seed layer 12 and the anode. This causes the formation of the stencil, as shown in FIG. 6.

FIG. 7 shows an example of the bi-polar AC current waveform used. Preferably, the bi-polar signal includes a continuous stream of these waveforms, although off times, during which no current is applied, could be used if and when desired. The waveform of FIG. 7 is square and consists of a cathodic pulse 22 and an anodic pulse 24. By cathodic pulse, it is meant that part of the bi-polar waveform that causes deposition of metal. By anodic pulse, it is meant that part of the bi-polar waveform that causes removal of metal. In the case of the waveform shown in FIG. 7, the cathodic pulse is represented by the positive pulse 22 and the anodic pulse is represented by the negative pulse 24.

The cathodic pulse 22 has a longer duration, preferably at least double, than the anodic pulse 24 and has a lower peak forward current. The anodic pulse 24 is much shorter, but has a relatively high peak current. The average current density of the cathodic pulse 22 is greater than that of the anodic pulse 24.

The bi-polar AC current waveform used is typically in the millisecond range 1 ms-999 ms, with a greater anodic to cathodic pulse ratio, and a shorter anodic pulse time than cathodic pulse time. The voltage range depends on the size of the wafer. For example, for an eight-inch wafer, the voltage used was 12V, but between 1 to 100 volts is possible. It should be noted that in general it is preferred that voltage is controlled and it is the current that is varied, although of course, it is possible also to vary the voltage waveform with respect to current. The current typically ranges anywhere from 1 Am/dm² to 50 A/dm², where A/dm²=Amps per decimeter squared. The average current density is usually from 3-10 A/dm². A typical waveform for plating pure nickel has an average current density of 7 A/dm², a frequency of 20 Hz (50 ms), a cathodic pulse duration of 45 ms at 10 A/dm², and an anodic pulse duration of 5 ms at 20 A/dm².

Once the desired thickness of the material has been reached, the electroplating process is stopped and the wafer with its electro-formed stencil 20 is removed from the solution. The stencil 20 is then removed from the substrate 10. This can be done by merely peeling the stencil 20 off the wafer/substrate. At this stage, the resist mesas 18 infill the apertures, as shown in FIG. 8. The resist is removed using a suitable solvent, thereby leaving the stencil 20, as shown in FIG. 9. For SU-8 the preferred solvent is MS111, which is available from Miller Stephens Corporation, USA. The stencil 20 is then cleaned to remove any residual MS-111 and SU-8. This can be done by blowing dry the stencil in nitrogen. The stencil is then mounted in a frame (not shown) using conventional mounting techniques, so that it can then be used for printing in the electronic substrate fabrication and electronic assembly line industries.

Using a bi-polar AC current to electroform a metal stencil provides good metal deposition uniformity, and allows very fine features to be defined. By varying the pulse parameters, it is possible to control the material properties of the stencil, such as the hardness and surface roughness. This is because, by controlling the waveform parameters, it is possible to alter deposition of the stencil at an atomic level. The pulse parameters that can be varied include the frequency and/or relative widths of the cathodic and anodic pulses and/or relative heights of the cathodic and anodic pulses. In practice, it has been found that at higher frequencies surface smoothness is improved, whereas at lower frequencies, surface roughness is increased. As an example, for the specific stencil forming process described above, it was found that using a frequency of 100 Hz provided a smooth surface, whereas using 4 Hz or DC produced a rougher surface. Hence, by varying the frequency surface properties can be varied.

The bi-polar electro-forming stencil manufacture technique in which the invention is embodied provides various advantages. For example, in contrast to conventional DC techniques, when bi-polar pulses are used, the electroplating process does not require the use of organic additives in the electroplating bath. These additives are costly and difficult to maintain, and removing them from the process lessens the need for monitoring equipment to monitor the additive mixes. The method also provides a very even distribution of metal across the stencil. In addition, it provides a mechanism for controlling material properties, such as hardness, intrinsic stress and crystal structure. This enables the possibility of providing a rough upper surface for the stencil to aid printing but at the same time providing very smooth sidewalls in order to perfectly release paste. Furthermore, the current efficiency is improved, which decreases hydrogen formation, thus lowering pitting and decreasing residual stress.

A skilled person will appreciate that variations of the disclosed arrangements are possible without departing from the invention. For example, whilst the stencil is described as being formed using a negative photo-resist, a positive resist could equally be used. In addition, although the stencil is described above as being peeled away from the substrate other options are possible. For example, the mould may be provided on an intermediary layer that is carried by the conducting surface. The intermediary layer may be a sacrificial lift-off layer that can be dissolved away, thereby to allow easy removal of the stencil from the substrate. The sacrificial lift off layer (not shown) could be deposited between the metal seed layer and the stencil layer. Alternatively, a sacrificial substrate that can be dissolved away could also be used. Furthermore, whilst the waveforms described above are all square, spike waveforms and sinusoidal waveforms are also suitable. Accordingly, the above description of a specific embodiment is made by way of example only and not for the purposes of limitation. It will be clear to the skilled person that minor modifications may be made without significant changes to the operation described.

1-34. (canceled)

35. A method of forming a screen-printing stencil for use in the electronic substrate fabrication and electronic assembly industries, the method comprising the step of: electroforming the stencil using a bi-polar electrical signal that comprises a plurality of bi-polar waveforms, each having a cathodic pulse and an anodic pulse.

36. A method as claimed in claim 35, wherein the cathodic pulse has a longer duration than the anodic pulse.

37. A method as clamed in claim 36, wherein the cathodic pulse has a duration that is at least twice the duration of the anodic pulse.

38. A method as claimed in claim 37, wherein a ratio of the durations of the cathodic and anodic pulses is in the range of 2:1 to 100:1.

39. A method as claimed in claim 35, wherein the cathodic pulse has a lower peak value than the anodic pulse.

40. A method as claimed in claim 39, wherein a ratio of the peak value of the cathodic pulse to the peak value of the anodic pulse is in the range of 1:1.5 to 1:20.

41. A method as claimed in claim 35, wherein the bi-polar signal is square or spiked or sinusoidal.

42. A method as claimed in claim 35, wherein the bi-polar waveform has a pulse width in the range of 1 ms-999 ms.

43. A method as claimed in claim 35, wherein the bi-polar waveform is a current waveform.

44. A method as claimed in claim 43, wherein an average current density of the anodic pulse is less than an average current density of the cathodic pulse.

45. A method as claimed in claim 43, wherein peak current density is in the range from 1 Am/dm² to 50 A/dm².

46. A method as claimed in claim 43, wherein the average current density is in the range of 3-10 A/dm².

47. A method as claimed in claim 35, wherein the bi-polar waveform is a voltage waveform.

48. A method as claimed in claim 35 comprising varying the bi-polar signal.

49. A method as claimed in claim 48 comprising varying any one of signal frequency, the durations of the cathodic and anodic pulses, the magnitudes of the cathodic and anodic pulses, relative durations of the cathodic and anodic pulses and relative magnitudes of the cathodic and anodic pulses.

50. A method as claimed in claim 35, wherein the step of electroforming the stencil comprises providing a mould on a conducting surface, the mould defining exposed areas of the conducting surface; immersing the mould and conducting surface in an ionic solution and electroplating areas exposed by the mould using the bi-polar current or voltage signal.
